(19) United States
(12) Patent Application Publication
(10) Pub. No.: US 2026/0120513 A1
(43) Pub. Date: Apr. 30, 2026

(54) EXPLANABILITY FOR DEEPFAKE MODELS

(71) Applicant: Claritas Software Solutions Ltd, Tel-Aviv (IL)

(72) Inventors: Michael MATIAS, Tel Aviv (IL); Allon Marc ODED, Tel Aviv (IL); Gil AVRIEL, Mevaseret Zion (IL); Natalie FRIDMAN, Petach Tikva (IL); Shmuel UR, Shorashim (IL)

(73) Assignee: Claritas Software Solutions Ltd, Tel-Aviv (IL)

(21) Appl. No.: 18/925,074

(22) Filed: Oct. 24, 2024

(51) Int. Cl. G06V 40/40; G06T 5/20; G06T 7/11; G06V 10/764

(52) U.S. Cl. CPC G06V 40/40; G06T 5/20; G06T 7/11; G06V 10/764

(57) ABSTRACT

There is provided a computer implemented method of explainability of a media element identified as deepfake, comprising: feeding the media element into a deepfake model trained to classify the media element as deepfake or not deepfake, wherein the deepfake model is implemented as a non-explainable model, in response to the deepfake model classifying the media element as deepfake: automatically dividing the media element into a plurality of sub-regions, for each respective sub-region of the plurality of sub-regions, creating a synthetic media element including the respective sub-region and excluding other sub-regions, feeding each of a plurality of synthetic media elements into the deepfake model, in response to the deepfake model classifying at least one of the synthetic media elements as being deepfake, creating a presentation indicating the sub-region corresponding to each at least one synthetic media elements classified as deepfake.

### BACKGROUND

The present invention, in some embodiments thereof, relates to machine learning models and, more specifically, but not exclusively, to machine learning models for detection of manipulated media items.

Media items may be manipulated, for example, using deepfake technology to create synthetic videos and/or synthetic audio, which may be of a higher enough quality to fool users.

### SUMMARY

According to a first aspect, a computer implemented method of explainability of a media element identified as deepfake, comprises: feeding the media element into a deepfake model trained to classify the media element as deepfake or not deepfake, wherein the deepfake model is implemented as a non-explainable model, in response to the deepfake model classifying the media element as deepfake: automatically dividing the media element into a plurality of sub-regions, for each respective sub-region of the plurality of sub-regions, creating a synthetic media element including the respective sub-region and excluding other sub-regions, feeding each of a plurality of synthetic media elements into the deepfake model, in response to the deepfake model classifying at least one of the synthetic media elements as being deepfake, creating a presentation indicating the sub-region corresponding to each at least one synthetic media elements classified as deepfake.

According to a second aspect, a system for explainability of a media element identified as deepfake, comprises: at least one processor executing a code for: feeding the media element into a deepfake model trained to classify the media element as deepfake or not deepfake, wherein the deepfake model is implemented as a non-explainable model, in response to the deepfake model classifying the media element as deepfake: automatically dividing the media element into a plurality of sub-regions, for each respective sub-region of the plurality of sub-regions, creating a synthetic media element including the respective sub-region and excluding other sub-regions, feeding each of a plurality of synthetic media elements into the deepfake model, in response to the deepfake model classifying at least one of the synthetic media elements as being deepfake, creating a presentation indicating the sub-region corresponding to each at least one synthetic media elements classified as deepfake.

In a further implementation of the first aspect and second aspect, the synthetic media element includes the respective sub-region of the media element, and values denoting lack of information for the excluded sub-regions.

In a further implementation of the first aspect and second aspect, further comprising in response to the deepfake model classifying any of the synthetic media as deepfake, further dividing each sub-region into a plurality of sub-sub-regions, wherein the synthetic media element includes the respective sub-sub-region and excludes other sub-sub-regions.

In a further implementation of the first aspect and second aspect, the automatically dividing, the creating, and the feeding, are iterated in a plurality of iterations by further dividing each sub-region into a plurality of smaller sub-sub-regions, wherein the plurality of iterations are terminated when the deepfake model does not classify any synthetic media elements of a certain sub-region as deepfake.

In a further implementation of the first aspect and second aspect, a different ensemble of deepfake models is applied at different iterations, wherein more computationally expensive deepfake models are applied at relatively later iterations.

In a further implementation of the first aspect and second aspect, the deepfake model generates a classification in response to an input and excludes an indication of specific features of the input that most significantly contributed to the classification.

In a further implementation of the first aspect and second aspect, the synthetic media element is generated in a format designed to comply with requirements for input into the deepfake model.

In a further implementation of the first aspect and second aspect, the synthetic media element is created by creating a mask corresponding to the respective sub-region, and applying the mask to the media element.

In a further implementation of the first aspect and second aspect, the synthetic media element is created for avoiding or reducing likelihood of the deepfake model classifying the synthetic media element as deepfake based on the excluded sub-regions.

In a further implementation of the first aspect and second aspect, the excluded sub-regions are generated for being non-significant for classification by the deepfake.

In a further implementation of the first aspect and second aspect, the media element comprises a video, wherein the video or image is divided into a plurality of sub-regions by segmenting a plurality of objects, each synthetic media element includes a respective object and excludes other objects and background during a time-interval of the video classified as deepfake. In a further implementation of the first aspect and second aspect, the media element comprises a video or image, wherein the video or image is divided into a plurality of sub-regions each including an area of a frame of the video or of the image.

In a further implementation of the first aspect and second aspect, the media element comprises an audio file, wherein the audio file is divided into a plurality of sub-regions according to frequency ranges and/or sound sources, each synthetic media element includes a respective frequency range and excludes other frequency ranges, and/or includes sound from a respective sound source and excludes sound from other sound sources, during a time-interval of the audio classified as deepfake.

In a further implementation of the first aspect and second aspect, further comprising providing a plurality of different media elements, wherein the features of claim 1 are iterated for each media element of the plurality of different media elements, for selecting a sub-set of media elements classified as deepfake, and creating a respective presentation for each media element of the sub-set.

In a further implementation of the first aspect and second aspect, the presentation includes a marking on the media element, each sub-region classified as deepfake.

In a further implementation of the first aspect and second aspect, the deepfake model comprises an ensemble of deepfake models each trained to analyze different features and/or different objects of a target media element for classifying the target media element as deepfake, wherein the presentation further includes at least one indication of a specific feature and/or a specific object of a certain deepfake model of the ensemble that classified the media element as deepfake.

In a further implementation of the first aspect and second aspect, further comprising processing the media element and/or processing each sub-region by at least one of: applying a filter and/or changing from color to greyscale, wherein the plurality of synthetic media elements are created based on the processed sub-regions.

In a further implementation of the first aspect and second aspect, the media element is at a first resolution, dividing the media element into the plurality of sub-regions comprises converting the media element to a second resolution lower than the first resolution, and in response to classifying the at least one of the synthetic media elements as deepfake at the second resolution, for the sub-region of the at least one synthetic media elements switching to a third resolution higher than the second resolution and iterating the features of the method of claim 1 for the sub-region at the third resolution.

According to a third aspect, a computer implemented method of explainability of a media element identified as deepfake, comprises: feeding the media element into each of a plurality of deepfake models of an ensemble, each deepfake model trained to analyze a specific feature for classifying the media element as deepfake or not deepfake, identifying a sub-set of the plurality of deepfake models of the ensemble that classified the media element as deepfake, and generating a presentation comprising specific features indicated with respect to the media element, wherein the specific features that are indicated correspond to the sub-set of the plurality of deepfake models that classified the media element as deepfake.

In a further implementation of the third aspect, further comprises: for each specific feature corresponding to a specific deepfake model: analyzing the media element to detect a plurality of instances of the specific feature, automatically dividing the media element into a plurality of sub-regions each include a respective instance of the specific feature, for each respective sub-region of the plurality of sub-regions, creating a synthetic media element including the respective sub-region and excluding other sub-regions, feeding each of a plurality of synthetic media elements into the corresponding specific deepfake model, wherein the presenting indicates the instance of the specific feature corresponding to the sub-region of the synthetic media element identified by the deepfake model as likely deepfake.

In a further implementation of the third aspect, the presentation includes markings and/or explanations for plurality of different specific features corresponding to a sub-set of the plurality of deepfake models of the ensemble classifying the media element as deepfake.

In a further implementation of the third aspect, the media element comprises a video, the specific feature includes a specific object depicted in the video, and the presentation includes the specific object marked on the video.

In a further implementation of the third aspect, the media element comprises audio, the specific feature includes a specific audio feature, and the presentation includes an explanation of the specific audio feature or playing the specific audio feature over speakers.

In a further implementation of the third aspect, the presentation includes a text explanation of the specific features that the sub-set of the plurality of deepfake models that detected deepfake analyze.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic of components of a system 100 for explainability of a media item identified as deepfake, in accordance with some embodiments of the present invention.

FIG. 2 is a flowchart of a method of generating explainability for a media item identified by at least one deepfake model as deepfake, in accordance with some embodiments of the present invention;

FIG. 3 is a flowchart of another method of providing explainability of a media element identified as deepfake, in accordance with some embodiments of the present invention;

FIG. 4 is a flowchart of an exemplary method for providing explainability of a media item identified as deepfake based on a combination of explainable models and non-explainable models, in accordance with some embodiments of the present invention;

FIG. 5 is a flowchart of an exemplary method for searching for an object of a media item that triggered classification of deepfake, in accordance with some embodiments of the present invention;

FIG. 6 is a flowchart of an exemplary method for searching for a sub-region of a media item that triggered classification of deepfake, in accordance with some embodiments of the present invention;

FIG. 7 is a flowchart of an exemplary method for searching for a frequency of an audio media item that triggered classification of deepfake, in accordance with some embodiments of the present invention; and

FIG. 8 is a flowchart of an exemplary use-case of legal proceedings using explainability of media items found to be deepfake, in accordance with some embodiments of the present invention.

### DETAILED DESCRIPTION

The present invention, in some embodiments thereof, relates to machine learning models and, more specifically, but not exclusively, to machine learning models for detection of manipulated media items.

As used herein, the terms media item and media element are interchangeable.

As used herein, the term deepfake with reference to a media item may refer to a media item created by a deepfake technology (e.g., video that is not captured by a video camera but synthetically created by a deepfake generator), and/or a media item with an portion thereof created by the deepfake technology (e.g., video with a face of an actor swapped with a face of politician). The term deepfake may refer to manipulation of the media item from its original version, for example, a misleading cut of multiple combined videos to create a single video (and/or audio), and/or replacing the voice of one person by the voice of a different person (which is notably different than a fake computer generated voice).

As used herein, the term deepfake and manipulated (or manipulation) may be sometimes be interchanged. The term deepfake is more commonly used in the context of generative models (i.e., generative artificial intelligence (GenAI)), and the term manipulation is more commonly used in the context of video editing and/or voice impersonation. It is to be understood that embodiments described herein with reference to deepfake may be used to detect manipulated media items. For example, the deepfake model for detecting deepfake media items may be implemented as a manipulation model for detecting manipulated media items which may be created using approaches other than deepfake technology based approaches. As used herein the term deepfake is sometimes used to refer to manipulation of video editing and/or voice impersonation and is not meant to be implied as referring exclusively to deepfake technology in such cases, but may be substituted for the term manipulation, indicating manipulations which may not necessarily be performed using deepfake technology.

As used herein, the term deepfake model refers to a model trained to detect whether an input media item is deepfake or likely deepfake, i.e., created by a deepfake technology. The term deepfake model and deepfake detector model are interchangeable.

As used herein, the term explainability (for a media item) refers to the reason that the media items is suspected as being deepfake. Explainability may refer to a specific feature of the media item which is used to suspect the media item as being deepfake. For example, eyes of a person in a video are not pointing in a common direction, audio of a person speaking in a video is not synchronized to movement of lips of the person, and a pattern of a shadow on objects depicted in a video appears to contradict the location of a light source in the video.

As used herein, the term non-explainable deepfake model refers to a machine learning model trained to identify whether an input media item is likely deepfake or not (e.g., classifier, and/or generates a likelihood score such a probability), whose decision-making process is not transparent or understandable, making it difficult or practically impossible to explain how or why it arrived at a particular outcome. Some types of model architectures make it difficult or practically impossible to explain what feature of the input media item led to the deepfake model classifying the input media item as deepfake, for example, a neural network with layers of connected neurons from which the reason for the classification cannot be extracted.

As used herein, the term explainable deepfake model refers to a machine learning model trained to identify whether an input media item is likely deepfake or not (e.g., classifier, and/or generates a likelihood score such a probability), whose decision-making process is more transparent and/or understandable based on the knowledge of specific features analyzed the deepfake model. Each explainable deepfake models are trained to analyze a specific feature or set of related features to determine whether a media item is deepfake or not. Therefore, when the explainable deepfake model classifies the media item as deepfake, a user may inspect the specific features (which are used by the deepfake model) of the media item. For example, one type of deepfake model analyzes eyes of people in a video, to determine whether the eyes are oriented correctly. Another type of deepfake model analyzes a shadow pattern in a video, to determine whether the shadow pattern corresponds to a location of lighting in the video.

As used herein the term classify, or classification, such as the deepfake model classifies an input media element into the classification category indicating deepfake or not deepfake, is not necessarily meant to be limiting. Classification may refer to assigning a score indicative of likelihood of deepfake, for example, a probability. The score may be evaluated relative to a threshold, for example, scores above the threshold indicative deepfake and scores below the threshold indicate not deepfake. The terms classification and score may sometimes be interchanged.

An aspect of some embodiments of the present invention relates to systems, methods, computing devices, and/or code instructions, for explainability of a media element identified as deepfake by a non-explainable deepfake model, optionally a deepfake model trained to classify the media element as deepfake or not deepfake, without indicating reasoning for the classification. In response to the deepfake model classifying the media element as deepfake, the media element is automatically divided into multiple sub-regions. For example, an image is segmented into different objects or parts (e.g., body parts), an image is divided into different regions such as by applying a grid, and an audio recording is divided into different frequencies and/or different sound sources. For each respective sub-region, a synthetic media element is created. The synthetic media element includes the respective sub-region and excludes other sub-regions. Optionally, the excluded sub-regions are replaced by values indicating lack of information, for example, pixel intensity values external to the respective sub-region are set to zero, and/or audio frequencies external to the respective sub-region are set to zero amplitude. Each synthetic media elements is fed into the deepfake model. In response to the deepfake model classifying at least one of the synthetic media elements as being deepfake, the sub-region included in the synthetic media element classified as deepfake serves as an explanation for the classification of the media element as deepfake by the deepfake model. For example, in a frame from a video showing multiple people and multiple objects classified as deepfake, a specific object and/or specific person included in a synthetic media element classified as deepfake may explain why the frame as a whole was classified as deepfake. The other objects and/or other people in the frame may not necessarily be classified as deepfake. A presentation indicating the sub-region corresponding to each synthetic media elements classified as deepfake may be created.

An aspect of some embodiments of the present invention relates to systems, methods, computing devices, and/or code instructions, for explainability of a media element identified as deepfake. The media element identified as deepfake is fed into each one of multiple deepfake models of an ensemble. Each deepfake model is trained to analyze a specific feature for classifying the media element as deepfake or not deepfake. Since each deepfake model is trained to analyze a specific feature rather than the media element as a whole, each deepfake model may be considered an explainable model on its own where the specific feature indicates why the media element is deepfake. A sub-set of the deepfake models of the ensemble that classified the media element as deepfake is identified. A presentation depicting specific features indicated with respect to the media element may be generated. The specific features that are indicated correspond to the sub-set of the deepfake models that classified the media element as deepfake.

At least one embodiment addresses the technical problem of explainability for a media item identified as deepfake by one or more deepfake models. At least one embodiment improves the technology of deepfake models for detecting deepfake media items, by providing explainability for a media identified as deepfake by one or more deepfake models. At least one embodiment improves upon prior approaches for providing explainability for a media identified as deepfake by one or more deepfake models.

In some cases, for example, legal proceedings, regulatory approval, medical, and the like, it is insufficient that a deepfake model identifies a certain media item as deepfake. The deepfake model cannot be treated as a blackbox, where the classification of deepfake is provided as absolute truth without understanding why. For example, in a legal proceeding, an accusation that a certain image is deepfake simply because the deepfake model said so is invalid. Evidence of why the image is deepfake must be provided. Such evidence, i.e., explainability, is provided using at least one embodiment described herein.

The problem is even more challenging when there is a large number of media items, for example, in legal proceedings where the other side would like to authenticate the media items. The authentication is difficult to handle manually as there are so many videos to inspect.

In other cases, for protecting (Detection, Authentication and Prevention) from Social Engineering performed via digital channels. Social engineering refers to the manipulation of individuals into performing actions or divulging confidential information. It exploits human psychology rather than technical vulnerabilities to gain unauthorized access to systems, data, or resources. Social engineering attacks often involve impersonation, deception, or persuasion to trick people into revealing sensitive information, such as passwords or financial details, or into performing actions like clicking malicious links or downloading malware. Social engineering can lead to security breaches, identity theft, or financial loss by manipulating users rather than attacking technical defenses.

The “traditional” Cyber today is Trusted communication between machines/network/cloud and including trusted communication between humans, especially in real-time (e.g., extending from email and SMS towards video and/or audio).
98% of cyberattacks rely on social engineering.
An average business organization faces over 700 social engineering attacks annually.
90% of data breach incidents target the human element to gain access to sensitive business information.
83% of businesses in the U.S. have fallen prey to some form of phishing attack; 95% of successful network intrusions rely on spear phishing techniques and only half of employees are able to define this term correctly.

Digital communication between humans may generate a large number of media elements, for example, a videoconference call may generate a large number of frames and/or a long audio track. A short portion of the media elements may be manipulated (e.g., using deepfake technology or other) as a form of social engineering, to manipulate a user. At least one embodiment described herein may be used for detection of deepfake within digital communication media (e.g., video conference applications and/or audio applications) and/or supportive incident management.

Prior approaches for providing explainability of machine learning models are unsuitable for providing explainability for models that detect likelihood of a media item being deepfake, such as neural networks for example:
Interpretability approaches such as SHAP (Shapley Additive exPlanations), LIME (Local Interpretable Model-Agnostic Explanations), and the like. These approaches cannot be used for explainability of complex models that detect deepfake.
Training on partial data to reduce overfitting. Partial data of the data is selected so that the neural network will not learn to identify the person, but deepfake. This approach requires access to the training data and to the training of the model. In contrast, embodiments described herein are able to treat the deepfake detection model as a black-block, and do not require access to the training data.
Gradient based approaches, which are white box type approach (i.e., look inside the neural network). Gradient-based approaches look at the gradient flowing backward through the model from the output decision to intermediate feature layers to understand which neurons in the model contribute the most to the output decision. The higher the gradient, the more this neural pathway contributes to the final output scores. Thus, given an input image, one can extract a heat map (also referred to as a saliency map) showing the regions contributing the most to the final decision of the model. This heat map may be overlaid onto the original input image for indicating where and by how much these regions influence the final decision. This approach requires access to the internal data of the model. In contrast, embodiments described herein are able to treat the deepfake detection model as a black-box, and do not require access to components within the model.

At least one embodiment provides explainability for a non-explainable deepfake model that serves as a “black box”, without requiring access to the internal components of the deepfake model. For example, at least one embodiment may be implemented as an “explaining” process that may be associated (e.g., connected) to a deepfake detector model, for providing explainability for the deepfake detector model without modification of the deepfake detector and/or without requiring access to internal components of the deepfake detector and/or without requiring access to the training dataset used to train the deepfake detector. The explainability may be derived by iteratively dividing the media item into sub-regions, feeding the sub-regions into the deepfake model, and analyzing which sub-regions and/or of which iterations results in a classification of deepfake and not likely deepfake. For example, an image of a person may be identified as deepfake. The person may be divided into parts, for example, head, torso, arms, and legs. Each of the parts is fed into the deepfake model. The head may be identified as deepfake, while the other body parts may by identified as likely not being deepfake. This provides the explanation that the head of the user is likely deepfake. A user may analyze the head in detail, rather than wasting time looking at other body parts which are not deepfake.

At least one embodiment addresses the technical problem of determining which media items of a corpus of media items are deepfake. The corpus of media items may be large, for example, on the order of hundreds or thousands of images and/or videos, and/or hundreds or thousands of hours of video and/or audio. The actual deepfake media items may be a small subset, for example, on the order of single numbers or tens of images and/or videos, and/or on the order of seconds and/or minutes of video and/or audio. It is impractical to sort through the large corpus to identify the deepfake media items. At least one embodiment improves the technology of image and/or video and/or audio analysis, by enabling quickly determining which media items of a corpus of media items are deepfake. At least one embodiment improves upon prior approaches for determining which media items of a corpus of media items are deepfake. Using prior approaches, a user manually sorts through the corpus in an attempt to identify the deepfake media items. Even if an automated approach is used, such as a deepfake detector model, at best, the deepfake detector model indicates the video and/or audio suspected to be deepfake. The user is then required to spend considerable time reviewing the video and/or audio in order to determine if the media item is actually deepfake or if the detector model made an error.

At least one embodiment addresses the aforementioned technical problem(s), and/or improves upon the aforementioned technical field(s), and/or improves upon the aforementioned prior approach(es), by providing explainability of a media element identified as deepfake by a non-explainable deepfake model, optionally a deepfake model trained to classify the media element as deepfake or not deepfake, without indicating reasoning for the classification. In response to the deepfake model classifying the media element as deepfake, the media element is automatically divided into multiple sub-regions. For each respective sub-region, a synthetic media element is created. The synthetic media element includes the respective sub-region and excludes other sub-regions. Each synthetic media element is fed into the deepfake model. In response to the deepfake model classifying at least one of the synthetic media elements as being deepfake, the sub-region included in the synthetic media element classified as deepfake serves as an explanation for the classification of the media element as deepfake by the deepfake model. A presentation indicating the sub-region corresponding to each synthetic media element classified as deepfake may be created.

For example, a video is classified as deepfake by a deepfake detector model. The video is divided into objects, such as different people, for example, by segmenting the people in frames of the video. Synthetic media items are created, where each synthetic media item includes one person and excludes the other people. Feeding the synthetic media items into the deepfake detector model may indicate the specific person (i.e., object) and frames (i.e., time) that led to the deepfake classification. For example, if there are 8 people in the video, a specific person that triggers the deepfake classification and time of trigger is found. A presentation indicating the time of video and indication of the specific person may be generated.

At least one embodiment addresses the aforementioned technical problem(s), and/or improves upon the aforementioned technical field(s), and/or improves upon the aforementioned prior approach(es), by providing explainability of a media element identified as deepfake. The media element identified as deepfake is fed into each one of multiple deepfake models of an ensemble. Each deepfake model is trained to analyze a specific feature for classifying the media element as deepfake or not deepfake. A sub-set of the deepfake models of the ensemble that classified the media element as deepfake is identified. A presentation depicting specific features indicated with respect to the media element may be generated. The specific features that are indicated correspond to the sub-set of the deepfake models that classified the media element as deepfake.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

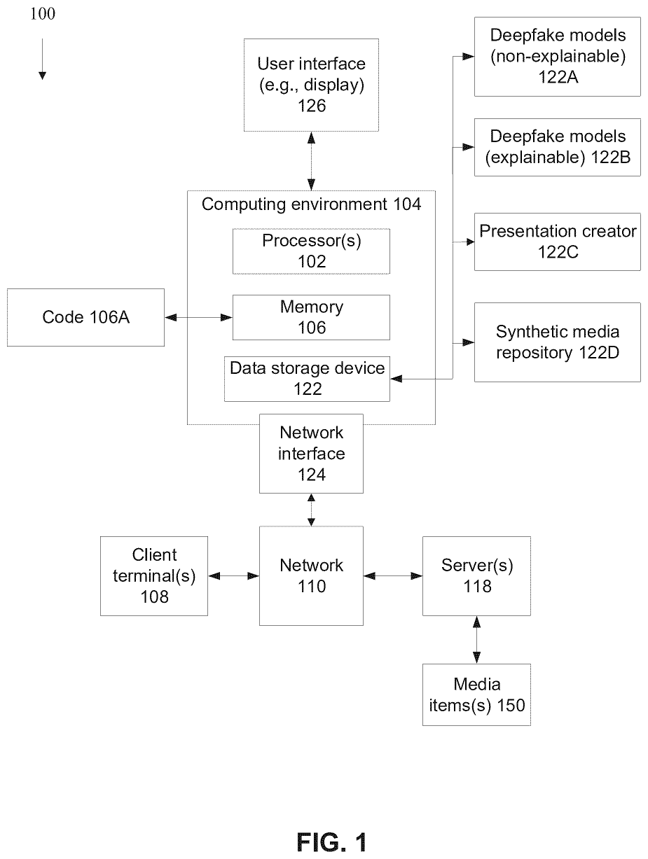

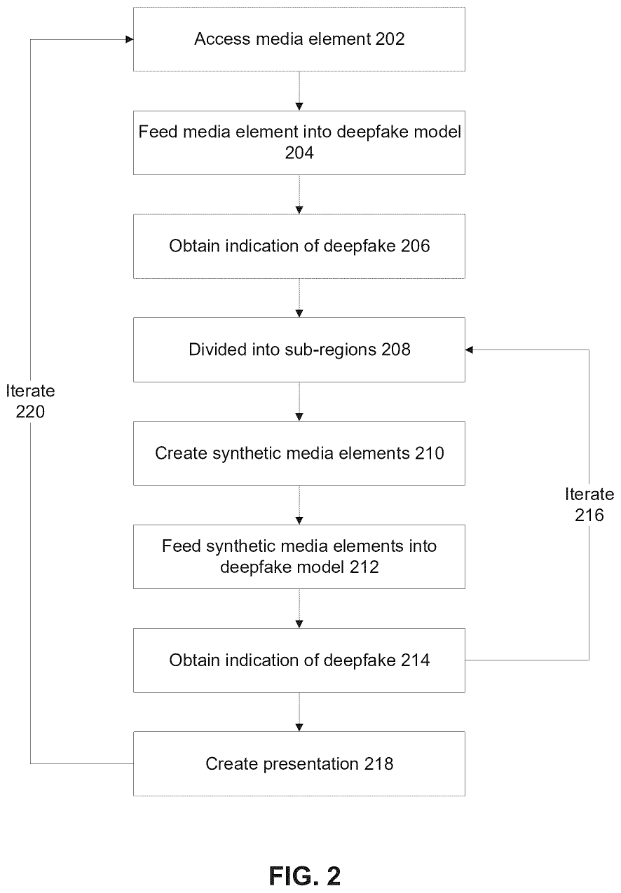

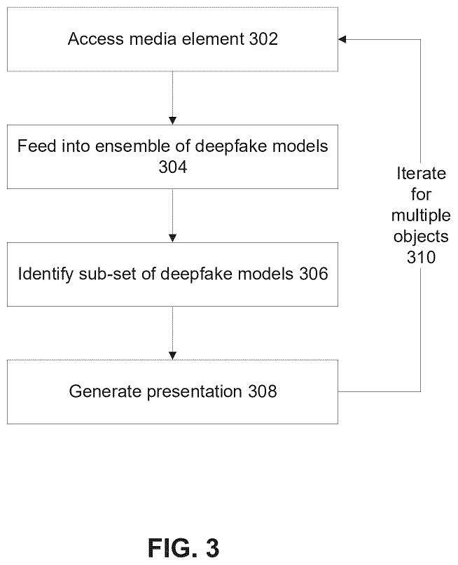

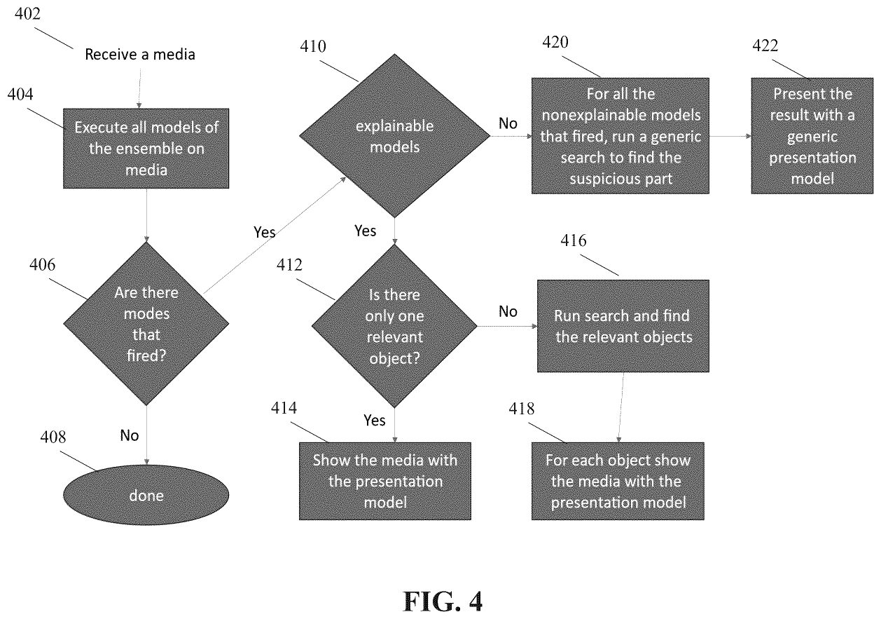

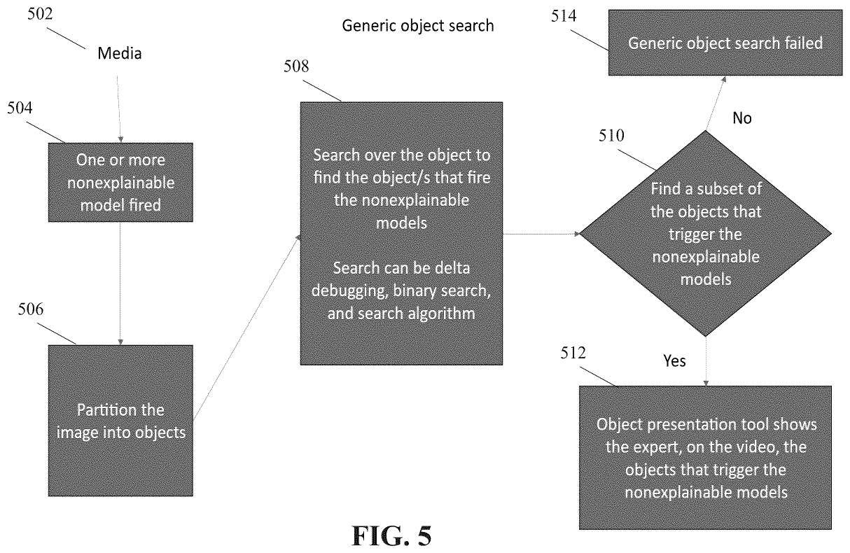

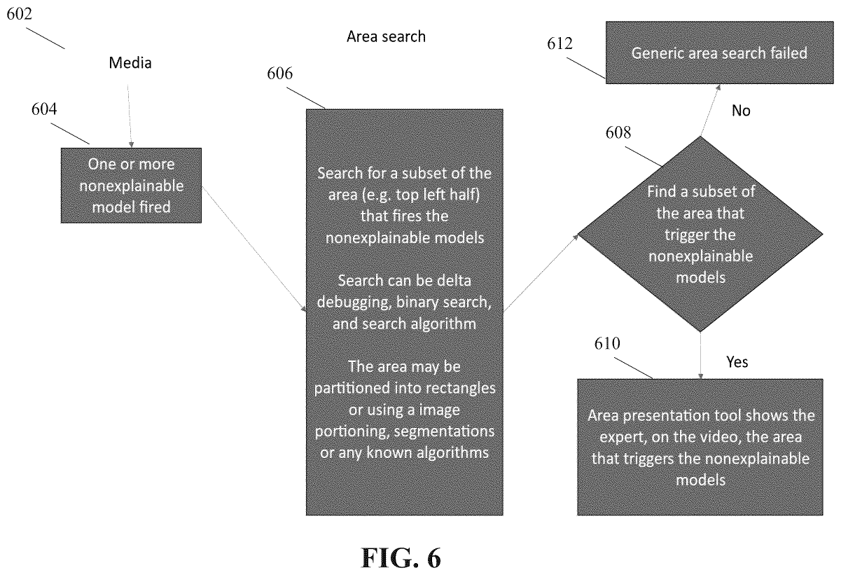

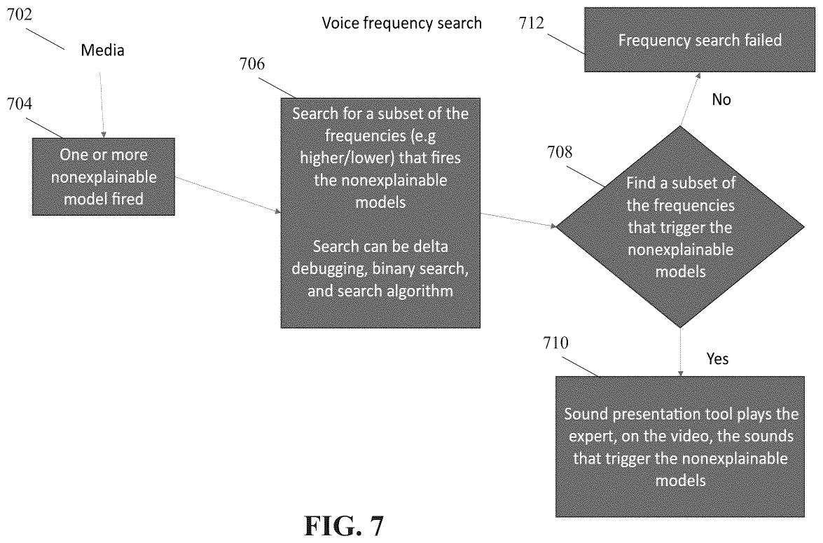

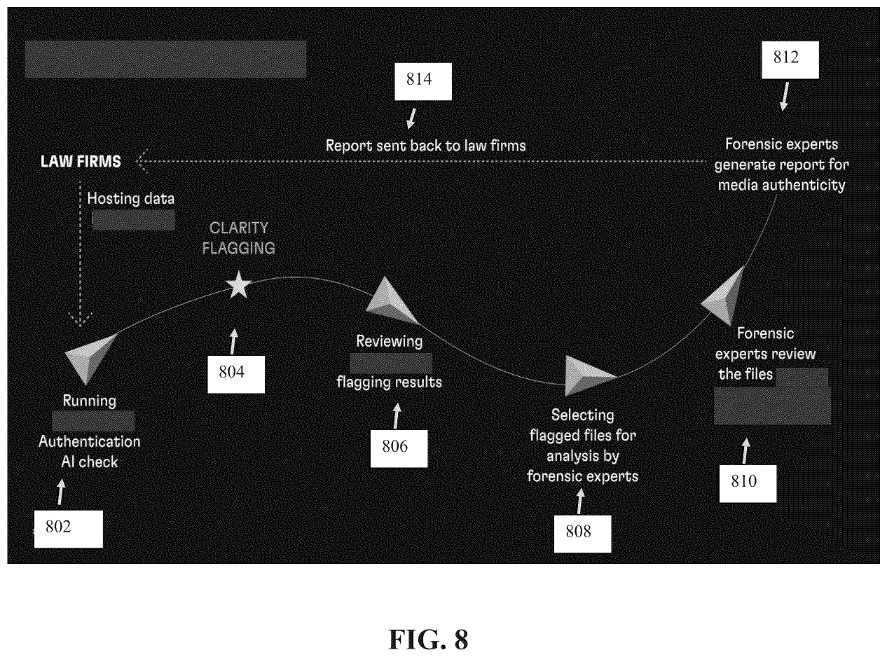

Reference is now made to FIG. 1, which is a schematic of components of a system 100 for explainability of a media item identified as deepfake, in accordance with some embodiments of the present invention. Reference is also made to FIG. 2, which is a flowchart of a method of generating explainability for a media item identified by at least one deepfake model as deepfake, in accordance with some embodiments of the present invention. Reference is also made to FIG. 3, which is a flowchart of another method of providing explainability of a media element identified as deepfake, in accordance with some embodiments of the present invention. Reference is also made to FIG. 4, which is a flowchart of an exemplary method for providing explainability of a media item identified as deepfake based on a combination of explainable models and non-explainable models, in accordance with some embodiments of the present invention. Reference is also made to FIG. 5, which is a flowchart of an exemplary method for searching for an object of a media item that triggered classification of deepfake, in accordance with some embodiments of the present invention. Reference is also made to FIG. 6, which is a flowchart of an exemplary method for searching for a sub-region of a media item that triggered classification of deepfake, in accordance with some embodiments of the present invention. Reference is also made to FIG. 7, which is a flowchart of an exemplary method for searching for a frequency of an audio media item that triggered classification of deepfake, in accordance with some embodiments of the present invention. Reference is also made to FIG. 8, which is a flowchart of an exemplary use-case of legal proceedings using explainability of media items found to be deepfake, in accordance with some embodiments of the present invention.

System 100 may implement the acts of the method described with reference to FIGS. 2-8, by processor(s) 102 of a computing device 104 executing code instructions stored in a memory 106 (also referred to as a program store).

Computing environment 104 may be implemented as, for example one or more and/or combination of: a group of connected devices, a client terminal, a server, a virtual server, a computing cloud, a virtual machine, a desktop computer, a thin client, a network node, and/or a mobile device (e.g., a Smartphone, a Tablet computer, a laptop computer, a wearable computer, glasses computer, and a watch computer).

Computing device 104 generates explainability for one or more media items 150 (e.g., videos, audio files, images) identified as deepfake by one or more non-explainable deepfake models 122A and/or by explainable deepfake model 122B, such as which features of the media item 150 led to the deepfake model(s) 122A and/or 122B to identify the media item 150 as deepfake, for example, eyes of a specific person in the video, pattern of a shadow cast on objects in the video, and/or audio not synchronized to moving lips of a person in the video.

Multiple architectures of system 100 based on computing device 104 may be implemented. For example:
Computing device 104 may be implemented as a standalone device (e.g., workstation, kiosk, client terminal, smartphone) that include locally stored code instructions 106A that implement one or more of the acts described with reference to FIGS. 2-8, for locally generating explainability for a media item 150 identified as deepfake by deepfake models 122A and/or 122B. The locally stored code instructions 106A may be obtained from a server, for example, by downloading the code over the network, and/or loading the code from a portable storage device. Media item(s) 150 being evaluated for being created by deepfake technology may be obtained, for example, stored by a data storage device such as by a server(s) 118, by a user manually entering a path where media item(s) 150 is stored, intercepting media item(s) 150 being transferred by user(s) across a network, and/or a user activating an application that automatically analyzes media item(s) 150 stored on computing device 104 and/or accessed by computing device 104 (e.g., over a network 110, and/or stored on a data storage device 122). The computing device may locally generate explainability for media item(s) 150 using code 106A as described herein. The generated explainability for media item(s) 150, such as which features of the media item(s) 150 led to identification of the media item(s) 150 as being (or including) deepfake by deepfake models 122A and/or 122B may be presented on a display (e.g., user interface 126).
Computing device 104 executing stored code instructions 106A, may be implemented as one or more servers (e.g., network server, web server, a computing cloud, a virtual server) that provides centralized services (e.g., one or more of the acts described with reference to FIGS. 2-8). Services may be provided, for example, to one or more client terminals 108 over network 110, to one or more server(s) 118 over network 110, and/or by monitoring traffic over network 110. Traffic over network 110 may be monitored, for example, by a sniffing application that sniffs packets, and/or by an intercepting application that intercepts packets. Server(s) 118 may include, for example, social network servers that enable transfer of files including media item(s) 150 between users, and/or data storage servers that store data including media item(s) 150, which are accessed and/or downloaded by client terminals. Services may be provided to client terminals 108 and/or server(s) 118, for example, as software as a service (SaaS), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web sited hosted by computing device 104. For example, media item(s) 150 are provided from each respective client terminal 108 and/or server(s) 118 to computing device 104. In another example, media item(s) 150 are obtained from network 110, such as by intercepting and/or sniffing packets to extract videos from packet traffic running over network 110, for example, where the media item(s) 150 are being streamed and/or downloaded over network 110. In another example, media item(s) 150 are hosted by server(s) for viewing by users accessing the media item(s) 150, for example, by streaming and/or for download. Computing device 104 centrally generates explainability for one or more media items 150 (e.g., videos, audio files, images) identified as deepfake by one or more non-explainable deepfake models 122A and/or by explainable deepfake model 122B.
Deepfake models 122A and/or 122B may be hosted by computing device 104 and/or remotely accessed by computing device 104 (e.g., hosted by a remote server and accessed via an API). It is noted that access to the internal workings of deepfake models 122A and/or 122B is not required in order to generate the explainability.

Processor(s) 102 of computing device 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described with reference to FIGS. 2-8 when executed by hardware processor(s) 102.

Computing device 104 may include a data storage device 122 for storing data, such as one or more code based processes described herein, for example, non-explainable deepfake models 122A, explainable deepfake models 122B, presentation creator 122C for generating a presentation indicating the explainability, and/or synthetic media repository 122D which may be set for storing synthetic media generated from different regions of media items for feeding into non-explainable deepfake models 122B, as described herein. Data storage device 114 may be implemented as, for example, a memory, a local hard-drive, virtual storage, a removable storage unit, an optical disk, a storage device, and/or as a remote server and/or computing cloud (e.g., accessed using a network connection).

Network 110 may be implemented as, for example, the internet, a local area network, a virtual network, a wireless network, a cellular network, a local bus, a point to point link (e.g., wired), and/or combinations of the aforementioned.

Computing device 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 and/or client terminal(s) 108 include and/or are in communication with one or more physical user interfaces 126 that include a mechanism for a user to enter data (e.g., manually designate the location of media item(s) 150 for analysis) and/or view the displayed results (e.g., presentation of explainability for one or more media items 150 identified as deepfake), within a GUI. Exemplary user interfaces 126 include, for example, one or more of, a touchscreen, a display, gesture activation devices, a keyboard, a mouse, and voice activated software using speakers and microphone.

Reference is now made to FIG. 2, which is a flowchart of a method of providing explainability of a media element identified as deepfake, in accordance with some embodiments of the present invention.

Referring now back to FIG. 2, at 202, a media element is accessed.

The media element may be accessed, for example, selected for analysis manually by a user via a user interface, automatically accessed from a data storage device, accessed from a queue of media elements queued for analysis, intercepted during transmission over a network, and the like. Examples of media elements include: a video, an image, an animation, text, social network page, and an audio recording which may include voices of one or more people speaking and/or of music.

At 204, the media element is fed into one or more deepfake models. The deepfake model(s) may be trained to classify the media element as deepfake or not deepfake, or other corresponding classification categories such as deepfake or authentic, and the like. In another exemplary implementation, the deepfake model generates a probability or likelihood of the media element being deepfake. A threshold may be applied to the probability to obtain the classification category, for example, the threshold may be 50% or 60% or 70%, where probability values above the threshold are classified as deepfake and probability value below the threshold are classified as not deepfake. The classification and/or score may be temporal, assigned to defined time intervals of a video and/or audio.

The deepfake model may be implemented as a non-explainable deepfake model, from which a reason for the classification result cannot be obtained and/or is unreliable, and/or cannot be obtain without significant effort (e.g., long processing time, high processor resource utilization, and the like), as described herein. The non-explainable deepfake model generates a classification category (or other outcome) in response to an input of a media element, and excludes an indication of specific features of the input media element that most significantly contributed to the classification.

At 206, a classification of the input media element as deepfake is obtained from the deepfake model. It is noted that when alternatively a classification category indicating non-deepfake is obtained, the method may terminate.

At 208, the media element may be automatically divided into multiple sub-regions. Examples of sub-regions include:
Segmentations of different objects. For example, a scene of a movie is segmented into different people and different objects in the background, such as trees, furniture, cars, and the like. Each segmented object may be considered a sub-region.
An image may be divided into different areas, for example, by applying a virtual grid and/or dividing the area of the image into cells having shapes such as rectangles. For example, an image may be divided into 4, 8, 16, 25, 32, 64, or other number of cells. Each cell may be a sub-region.
The media element may be filtered and/or processed, where different filtered/processed media elements represent different sub-regions. For example, a color image may be converted into greyscale and/or other color palettes. The grey scale image and different palette images and/or the original color image may be considered different sub-regions. For example, the color image may be classified as deepfake while the black and white image may be classified as non-deepfake, which may indicate that the coloring is problematic.
An audio file may be divided into smaller sized chunks of different time intervals, where each time interval represents a sub-region. For example, a 60 second recording is divided into contiguous files of 5 seconds each.
An audio file may be divided into frequency ranges and/or sound sources, where each frequency range and/or sound originating from a certain sound source represents a sub-region. For example, an audio file includes words spoken by 3 different people. The audio of each person may be isolated and considered as a sub-region.

As described herein, the different sub-regions are automatically searched to determine whether one or more of the sub-regions trigger the non-explainable deepfake model to classify the sub-region as deepfake. Finding a certain sub-region classified as deepfake may assist in determining the reason for the overall classification of the media element as deepfake. For example, in a movie depicting multiple people which was classified as deepfake by the non-explainable model, a specific person is found to be classified as deepfake, while other people are not classified as deepfake. The specific person may be determined to be the reason that the video as a whole was classified as deepfake. The specific person may be analyzed in more detail, for example, to determine specific deepfake features, and the like.

At 210, a synthetic media element is created for each respective sub-region. The synthetic media element may include the respective sub-region and exclude other sub-regions. It is noted that the synthetic media element may include multiple sub-regions, for example, for improving efficiency of the search for specific sub-regions that are classified as deepfake.

The synthetic media element may be created for avoiding or reducing likelihood of the deepfake model classifying the synthetic media element as deepfake based on the excluded sub-regions. The excluded sub-regions may be processed in a way that clearly signals to the deepfake model that they are not deepfake, but rather regions which are to be excluded from consideration and/or excluded from processing. The excluded sub-regions may be generated for being non-significant for classification by the deepfake. For example, the excluded sub-regions may be set to values known to be ignored by the deepfake model. For example, pixel values of the excluded sub-regions may be set to zero or other value indicating that the pixels are to be excluded from processing and/or otherwise ignored by the deepfake model during classification. In the case of audio, the amplitude of the excluded sub-regions may be set to zero. This is to prevent the deepfake model from erroneously classifying the excluded sub-regions as deepfake.

The synthetic media element may include the respective sub-region of the media element, and values denoting lack of information for the excluded sub-regions. The synthetic media element may be created by creating a mask corresponding to the respective sub-region, and applying the mask to the media element. The mask may be applied to an image (e.g., video) and/or to audio. For example, a mask is applied externally to the sub-region, where masked values are set to a defined value such as zero. For example, in an image of segmented people, a synthetic image may be created for a specific person by applying a mask to pixels external to the segmentation of the specific person, setting masked pixel values to zero. The generated synthetic image includes the segmented specific person and excludes other background and/or other segmentations. In the case of audio, the mask may be applied to frequency ranges and/or sound sources representing excluded sub-regions, for setting amplitude of the excluded frequencies and/or source sources to zero. The generated synthetic sound source may include the selected frequency range and/or sound source and exclude other frequency ranges and/or other sound sources.

It is noted that the synthetic media element includes the sub-region of the original media element, with adapted values external to the sub-region which may be referred to as synthetic (e.g., setting pixel values to zero may be referred to as synthetic).

The synthetic media element may be generated in a format designed to comply with requirements for input into the deepfake model. The same deepfake model used to classify the media element as a whole may be used to classify the synthetic media element. For example, the deepfake model may be designed to classify images of specific dimensions. The synthetic media elements, which include respective sub-regions of the original image, may be created to comply with the specific dimensions. For example, using the original image, values of pixels external to the sub-region are set to zero in the synthetic image, thereby maintaining the same dimensions as the original image.

Examples of synthetic media elements include:
In the case where the media element includes a video or image, the video or image is divided into sub-regions by segmenting objects depicted therein. Each synthetic media element includes a respective object and excludes other objects and background. The synthetic media elements may be created from a time-interval of the video classified as deepfake.
In the case where the media element includes an audio file, wherein the audio file is divided into sub-regions according to frequency ranges and/or sound sources. Each synthetic media element includes a respective frequency range and excludes other frequency ranges, and/or includes sound from a respective sound source and excludes sound from other sound sources. The synthetic media elements may be created from a time-interval of the audio classified as deepfake.

At 212, each of the synthetic media elements may be fed into the deepfake model. The synthetic media elements may be fed into the same deepfake model used to classify the original media element from which the synthetic media elements are derived from. Alternatively or additionally, one or more other deepfake models are fed the synthetic media elements.

Synthetic media elements may be fed, for example, one at a time, to enable determining the classification for each respective synthetic media element.

At 214, one or more synthetic media elements classified by the deepfake model as deepfake are identified.

At 216, features described with reference to 208-214 may be iterated.

The iterations may be performed for improving computational efficiency of a computer searching for the sub-regions, i.e., corresponding synthetic media elements, classified as deepfake using one or more searching approaches. For example, reducing processing time for performing the search, and/or reducing utilization of processing resources for performing the search.

Iterations may be performed, for example, for different divisions of the media element into sub-regions. For example, a first round of iterations is for dividing the media element into areas via a grid for finding a specific area of the image that triggered the classification of deepfake, a second round of iterations is for dividing the media element into segmented objects for finding a specific segmented object that triggered the classification of deepfake, and a third round of iterations is for finding a specific frequency and/or sound source that triggered the classification of deepfake. The different searches enable searching different aspects of the media element to identify the cause of the deepfake classification. For example, dividing the image into cells may not identify a certain cell as deepfake when there is no problem of object boundaries. In another example, an analysis of sub-regions of an image will not identify a certain sub-region as deepfake when the deepfake is not within a visual component of a video. In yet another example, an analysis of sub-regions of audio will not identify a certain frequency range and/or sound source as deepfake when the deepfake is not within the audio component of the video.

Optionally, the iterations may be performed in response to the deepfake model classifying one or more of the synthetic media as deepfake. One or more sub-regions, optionally the sub-regions corresponding to the synthetic media classified as deepfake, may be divided into multiple sub-sub-regions. The synthetic media element includes the respective sub-sub-region and excludes other sub-sub-regions. For example, in an image depicting different people and different objects, a certain person (i.e., the synthetic media including the certain person) is found to trigger classification as deepfake. In a next iteration, the image of the certain person is divided into body parts (e.g., head, eyes, nose, neck, torso, arms, legs, and the like) denoting sub-sub-regions. The synthetic media elements each include a respective body part. In another example, the division is into area cells. An area cell that triggered a classification of deepfake may be further divided into smaller area cells. The iterations may terminate when, for example, the deepfake model does not classify any synthetic media elements of a certain sub-region as deepfake. This may suggest, for example, that the cells are too small to be processed for deepfake content, and/or that the deepfake classification is due to a combination of smaller cells. Alternatively or additionally, the iterations may terminate when, for example, all smaller area cells of a certain larger area cells are found to trigger a classification of deepfake, indicating that the certain larger area cells is entirely deepfake.

Optionally, a different ensemble of deepfake models is applied at different iterations. Optionally, more computationally expensive deepfake models are applied at relatively later iterations, and/or on iterations of smaller sub-regions. For example, a specific deepfake model that analyzes eyes which takes a significant amount of processing time to run and/or consumes a significant amount of processing resources may be run on segmentations of heads, after one or more preceding iterations which analyze larger regions of images, such as segmentations of bodies and/or larger cells using another more generic deepfake model which takes less processing time to run and/or consumes fewer processing resources that the specific deepfake model. It is noted that the additional other deepfake models may be run to improve explainability of classification of deepfake, rather than to improve accuracy and/or to or improve certainty.

Optionally, the original media element (e.g., accessed as described with reference to 202) is at a first resolution. The synthetic media element(s) may be created from the sub-region(s) by converting the media element to a second resolution lower than the first resolution. The second resolution may be, for example, a sample of frames of a video at a slower rate than the original video (e.g., two frames a second rather than the full frame rate), and/or may involve reducing pixel resolution of the image itself. The conversion to the second lower resolution may improve computational efficiency of a computer running the deepfake model, since processing high resolution images and/or audio may require significant processing time and/or significantly consume processing resources. In response to classifying the synthetic media element(s) at the second resolution as deepfake, the resolution of the sub-region used to create the synthetic media element(s) classified as deepfake may be converted to a third resolution higher than the second resolution. The third resolution may be lower than, equal to, or higher, than the first resolution. Features described with reference to 208-214 may be iterated for the sub-region at the third resolution. The analysis at the third higher resolution may improve explainability, such as by helping to more specifically identify the sub-region that is led to the classification of deepfake. For example, once a frame at the slower second resolution is found to be deepfake, the original frame rate may be used, such as to identify two consecutive frames that are stitched together to create deepfake content.

An example of an approach for searching a media element to identify a sub-region(s), such as subset of objects, that triggers classification of deepfake by the deepfake detector model is now described.

In an input image depicting 50 objects in the picture, a subset of objects denoted objects #15, 17 and 48, triggers classification of the image as deepfake. Any image fed into the deepfake detector model that includes objects #15, 17, and 48, will trigger the deepfake detector model to generate a classification of deepfake. Any image that does not include objects #15, 17, and 48, will not trigger the classification of deepfake. The goal of the search is to identify the subset that includes objects #15, 17, and 48.

A simple solution is now described:
For all objects o in O, check if O-o returns a deepfake classification when fed into the deepfake detector model. If it does not, o is needed. Take all the o's that are needed. (In this case all O-b will return a deepfake classification except for objects o being 15, 17, or 48, indicating therefore that objects #15, 17, and 48 are needed.)

A more complicated solution is now described:
Check whether the first half of the objects (or another subset other than half) are classified as deepfake. If classified as deepfake, continue searching in the first half (or other subset). Alternatively, if not classified as deepfake, check whether the second half of the objects are classified as deepfake. If classified as deepfake, continue searching in the second half (or other subset). If not classified as deepfake, i.e., meaning there are objects needed both in the first half and the second half to generate the deepfake classification, continue searching in the first half (while including the second half), and
continue searching in the second half (while maintaining all the first half).
For example, an image includes 8 objects, of which objects #2 and 7 are required for a deepfake classification. Start the search with the original image with all objects, which generates a deepfake classification, i.e., the image includes deepfake. The search is to find the specific objects that trigger the deepfake classification. Based on the aforementioned approach, repeat recursively:
Check the first half of objects #1-4. No classification of deepfake is obtained, since object #7 is missing.
Check the second half of objects #5-8. No classification of deepfake is obtained, since object #2 is missing.
Check the first half of objects, taking the second half of objects into account, by checking whether objects #1,2,5,6,7,8 trigger a classification of deepfake—(yes).
Check the first half of objects #1,5,6,7,8—no classification of deepfake.
Check the second half of objects #2,5,6,7,8—obtain classification of deepfake, indicating that object #2 is a trigger.
Also check the second half of objects #1,2,3,4 (the first half) and 5,6—no classification of deepfake is obtained.
Check objects #1,2,3,4,7,8-obtain classification of deepfake.
Check objects #1,2,3,4,7-obtain classification of deepfake.
Identify the two objects that generate the deepfake classification are 2 and 7.

At 218, a presentation indicating the sub-region(s) corresponding to each synthetic media element classified as deepfake, may be automatically generated. The presentation may be, for example, automatically played, saved as a file on a data storage device, printed, and/or forwarded to a remote computer.

The presentation may include one or more marking on the media element, indicating each sub-region classified as deepfake. The marking may be presented as an overlay over the media element. The marking may be, for example, a bounding box surrounding the sub-region classified as deepfake, a segmentation (e.g., of the sub-region classified as deepfake), an arrow pointing to the sub-region(s), pixel coding (e.g., increase pixel intensity brightness), text explaining the sub-region, and the like. For example, in a movie in which a specific person is determined to be deepfake, the movie is played while generating a segmentation border around the person, and/or by pointing an arrow to the person as the person moves around the scene. In the case of an audio media element, the presentation may include a playback of the sub-region (i.e., audio component) that triggered the classification of deepfake, optionally isolated from other audio components. Optionally, the synthetic audio that triggered the classification of deepfake is played. Synthetic voice may be added explaining, for example, in the following track the deep voice of the man is likely deepfake - followed by playing the deep voice of the man.

Optionally, the implementation of the deepfake model includes an ensemble of deepfake models each trained to analyze different features and/or different objects of a target media element for classifying the target media element as deepfake. In such implementation, the presentation may further includes at least one indication of a specific feature and/or a specific object of a certain deepfake model of the ensemble that classified the media element as deepfake.

At 220, one or more features described with reference to 202-218 may be iterated.

Optionally, the iterations are for each one of multiple different media elements. Each iteration may be for a respective media element. The iterations may be performed for selecting a sub-set of media elements classified as deepfake, and/or creating a respective presentation for each media element of the sub-set. For example, in court proceedings, there may be a large number of images and/or videos provided. A small number of these may be deepfake. Embodiments described herein enable efficiently identifying the subset classified as deepfake, and efficiently identifying reasons that media elements of the subset are classified as deepfake.

Referring now back to FIG. 3, at 302, a media element is accessed, for example, as described with reference to 202 of FIG. 2.

At 304, the media element is fed into each one of multiple deepfake models of an ensemble. Each deepfake model is trained to analyze a specific feature for classifying the media element as deepfake or not deepfake (or other corresponding categories), and/or for assigning a score, for example, a probability indicating likelihood of deepfake. The classification and/or score may be temporal, assigned to defined time intervals of a video and/or audio. The deepfake models trained to analyze specific features may be referred to herein as explainable models. Examples of specific features are described, for example, with reference to 308 of FIG. 3.

At 306, a sub-set of the deepfake models of the ensemble that classified the media element as deepfake are identified.

At 308, a presentation may be automatically created. The presentation may indicate, such as by marking and/or explanations, the specific feature corresponding to the subset of deepfake models of the ensemble that classified the media element as deepfake. For example, the specific feature may be automatically detected on the image and/or video, and marked. The presentation may include marking indicating the specific feature may be presented as an overlay over the media element. The marking may be, for example, a bounding box surrounding the specific feature classified as deepfake, a segmentation (e.g., of the specific feature), an arrow pointing to the specific feature, pixel coding (e.g., increase pixel intensity brightness), text explaining the specific feature(s), and the like. The presentation may be, for example, automatically played, saved as a file on a data storage device, printed, and/or forwarded to a remote computer.

In an example, when the media element is a video, and the specific feature includes a specific object depicted in the video, the presentation includes the specific object marked on the video. In another example, when the media element is an audio file, the specific feature includes a specific audio feature, and the presentation includes an explanation of the specific audio feature or playing the specific audio feature over speakers.

Optionally, a respective presentation is created per specific feature, i.e., per deepfake model that classified the media element as deepfake. This may enable different presentations according to the specific features, where the marking of the respective presentation may be selected to enhance the specific feature. Alternatively or additionally, the presentation may be a unified presentation that aggregates multiple results. For example, the same presentation depicts multiple specific features associated with multiple deepfake detector models that classified the media element as deepfake. The unified presentation may quickly indicate all known reasons that the media element is suspected to be deepfake.

Examples of specific features of a media item analyzed by deepfake models of the ensemble to determine whether the media item is deepfake, and corresponding presentations, include:
Analysis of eyes, for example, eye glazing. The eyes may be marked, for example, in a bounding box, with an arrow, and/or color coded. The presentation may include an indication of the problem with the eyes, for example, both eyes should be looking in the same direction, but are not, therefore deepfake manipulation is suspected.
Lip synching. The presentation may include a time in which there is a problem that the image does not fit the sound, and optionally a text indication explaining the problem. Optionally, the presentation indications an indication explaining that the sound expected from the video media item is absent, while a sound generated using deepfake technology appears to be present.
Different acoustic characteristics of the room. The presentation may show a sequence of frames in the video and explain that in earlier frames the acoustic characteristics (e.g., where the video was recorded) are different than in later frames.
Different person is impersonating the voice. The presentation may depict a part of the video and explain that according to the analysis, the person talking is not the person depicted in the part of the video.
Two videos are cut into one. The presentation may depict frames in the video where two videos are merged and/or split, or maybe where a part in the middle was cut out. For example, one portion of the video is not a continuation of the other portion of the video.

In an example, when the media element is a video, the specific feature includes a specific object depicted in the video. The presentation includes the specific object marked on the video. In another example, when the media element is an audio file, the specific feature includes a specific audio feature, and the presentation includes an explanation of the specific audio feature or playing the specific audio feature over speakers.

At 310, one or more features described with reference to 302-208 may be iterated.

Optionally, the iterations are for each one of multiple different media elements. Each iteration may be for a respective media element. The iterations may be performed for selecting a sub-set of media elements classified as deepfake, and/or creating a respective presentation for each media element of the sub-set.

Optionally, when the explainable model is fed multiple objects (e.g., image with multiple objects), and generates a classification category indicating deepfake, a search may be performed to identify the specific object that triggered the classification of deepfake. The search may be performed, for example, by analyzing the media element to detect multiple instances of the specific feature, and automatically dividing the media element into multiple sub-regions each include a respective instance of the specific feature. A synthetic media element is created by including each sub-region and excluding sub-regions. Each synthetic media element is fed into the corresponding explainable model to identify which synthetic media elements are classified as deepfake, for example, as described with reference to 208-214 of FIG. 2. The search may be performed on objects of the type that the explainable model is designed to analyze (e.g., faces) of which likely there are not that many in the image. As there could be multiple objects that trigger the classification of deepfake, when a regular search finds an object, the explainable model may be fed other objects to see if the first object was the triggering object, or whether other objects also trigger the deepfake classification. However, sometimes a simple is not enough. A search for different combinations of specific feature may be performed, by creating synthetic media elements from different combinations of specific features. For example, none of the specific features, when taken individually, triggers the classification of deepfake. A combination of specific features may trigger the classification of deepfake. For example, individual objects in an image are analyzed for distribution of light and/or shadows. Each individual object may appear to be authentic. However, a combination of objects in proximity to each other may indicate an abnormal/unnatural distribution of light and/or shadowing, indicating likelihood of deepfake.

Referring now back to FIG. 4, the method described with reference to FIG. 4 may be implemented by combining features of the methods described with reference to FIG. 2 and FIG. 3. In features 402-418, explainable models are used in an attempt to provide explainability for a media item identified as deepfake. In features 420-422, non-explainable models are used to provide explainability for the media item.

At 402, a media item is accessed, for example, as described with reference to 202 of FIGS. 2 and/or 302 of FIG. 3.

At 404, the media item may be fed into one or more deepfake detector models, which may include explainable and/or non-explainable models. The deepfake detector models may be arranged as an ensemble. For example, as described with reference to 204 of FIGS. 2 and/or 304 of FIG. 3.

At 406, a determination of whether one or more deepfake detector models classified the media items as likely being deepfake is made. For example, as described with reference to 206 of FIG. 2, and/or 306 of FIG. 3.

At 408, when no deepfake detector models classified the media item as deepfake, the media item may be determined to be authentic, i.e., not including features created by deepfake technology.

Alternatively, at 410, when one or more deepfake models classified the media item as deepfake, a sub-set of explainable deepfake models that classified the media item as deepfake are identified. For example, as described with reference 306 of FIG. 3.

At 412, a determination is made whether a single relevant feature (e.g., object) triggered an explainable deepfake model. For example, one explainable deepfake model that analyzed a specific feature classifies the media item as deepfake, while other explainable deepfake models that analyze other features classify the media item as not deepfake.

At 414, when the single relevant feature that triggered the classification of deepfake by the explainable deepfake model is determined, a presentation is generated indicating the single relevant feature, optionally with respect to the media item. For example, as described with reference to 308 of FIG. 3.

Alternatively, at 416, when more than one relevant feature is identified as triggering the classification of deepfake, a search may be executed to find which relevant features (e.g., objects) triggered the classification. For example, as described with reference to 310 of FIG. 3.

At 418, a presentation may be generated indication each relevant identified feature, optionally with respect for the media item. The presentation may aggregate multiple relevant identified feature. Alternatively, multiple presentations are generated, where each presentation indicates one relevant identified feature. For example, as described with reference to 310 of FIG. 3.

Alternatively or additionally to 410, at 420, a generic search may be performed using one or more non-explainable models that classified the media item as deepfake, to find which sub-regions trigger the classification of deepfake. For example, as described with reference to 208-216 of FIG. 2.

At 422, a generic presentation model may create a presentation indicating the identified sub-region that trigger the classification of deepfake, optionally with respect to the media item. For example, as described with reference to 218 of FIG. 2.

Referring now back to FIG. 5, features of the method described with FIG. 5 may be based on, and/or implemented by, and/or combined with, features of the method described with reference to FIG. 5.

At 502, a media item is accessed. For example, as described with reference to 202 of FIG. 2.

At 504, one or more non-explainable deepfake models classified the media item as deepfake. For example, as described with reference to 204-206 of FIG. 2.

At 506, the media item (e.g., image), is divided into objects. For example, as described with reference to 208 of FIG. 2. Synthetic media items may be created from the sub-regions. For example, as described with reference to 210 of FIG. 2.

At 508, a search may be done over the object, i.e., using the corresponding the synthetic media items, to identify the object(s) that triggers one or more non-explainable models to generate a classification of deepfake. The search may be performed, for example, using one or more approaches such as delta debugging, binary search, and/or other searches. For example, as described with reference to 216 of FIG. 2.

At 510, a subset of objects that trigger the classification of deepfake by one or more non-explainable models is identified. For example, as described with reference to 214 of FIG. 2.

At 512, a presentation depicting the subset of object(s) that trigger the classification of deepfake by one or more non-explainable models is generated. For example, as described with reference to 218 of FIG. 2.

Alternatively, at 514, when no objects that trigger the classification of deepfake are found, the generic search is determined to have failed. The media item may be identified (e.g., tagged) as authentic.

Referring now back to FIG. 6, features of the method described with FIG. 6 may be based on, and/or implemented by, and/or combined with, features of the method described with reference to FIG. 2.

At 602, a media item is accessed. For example, as described with reference to 202 of FIG. 2.

At 604, one or more non-explainable deepfake models classified the media item as deepfake. For example, as described with reference to 204-206 of FIG. 2.

At 606, the media item (e.g., image), is divided into sub-regions, i.e., different areas. The division into sub-regions may be done, for example, by dividing the image into rectangles (e.g., using a grid), using image portioning approaches, image segmentation approaches, and the like. For example, as described with reference to 208 of FIG. 2. Synthetic media items may be created from the sub-regions. For example, as described with reference to 210 of FIG. 2.

A search may be done over the sub-regions, i.e., using the corresponding the synthetic media items, to identify the sub-region that triggers one or more non-explainable model to generate a classification of deepfake. The search may be performed, for example, using one or more approaches such as delta debugging, binary search, and/or other searches. For example, as described with reference to 216 of FIG. 2.

At 608, a subset of sub-regions that trigger the classification of deepfake by one or more non-explainable models is identified. For example, as described with reference to 214 of FIG. 2.

At 610, a presentation depicting the subset of sub-region(s) that trigger the classification of deepfake by one or more non-explainable models is generated. The presentation may be generated by an area presentation tool. The presentation may depict the sub-region that triggered the classification of deepfake on the video, for example, by bounding boxes, color coding, arrows, and the like. For example, as described with reference to 218 of FIG. 2.

Alternatively, at 612, when no sub-regions that trigger the classification of deepfake are found, the generic search is determined to have failed. The media item may be identified (e.g., tagged) as authentic.

Referring now back to FIG. 7, features of the method described with FIG. 7 may be based on, and/or implemented by, and/or combined with, features of the method described with reference to FIG. 2.

At 702, an audio media item is accessed. The audio media item may include one or more voices of different speakers. For example, as described with reference to 202 of FIG. 2.

At 704, one or more non-explainable deepfake models classified the audio media item as deepfake. For example, as described with reference to 204-206 of FIG. 2.

At 706, the audio media item, is divided into frequencies, such as frequency ranges. For example, as described with reference to 208 of FIG. 2. Synthetic audio media items may be created from the frequency ranges. For example, as described with reference to 210 of FIG. 2.

A search may be done over the frequency ranges, i.e., using the corresponding the synthetic media items, to identify the frequency ranges (e.g., higher or lower) that trigger one or more non-explainable model to generate a classification of deepfake. The search may be performed, for example, using one or more approaches such as delta debugging, binary search, and/or other searches. For example, as described with reference to 216 of FIG. 2.

At 708, a subset of frequency ranges that trigger the classification of deepfake by one or more non-explainable models is identified. For example, as described with reference to 214 of FIG. 2.

At 710, a presentation depicting the subset of frequency ranges that trigger the classification of deepfake by one or more non-explainable models is generated. The presentation may be generated by a sound presentation tool. The presentation may include playing the sounds (e.g., frequency ranges) that trigger the classification of deepfake, for example, playing the sounds while the visual frames of the video are presented on a display. For example, as described with reference to 218 of FIG. 2.

Alternatively, at 712, when no frequency ranges that trigger the classification of deepfake are found, the frequency search is determined to have failed. The audio media item may be identified (e.g., tagged) as authentic.

Various embodiments and aspects of the present invention as delineated hereinabove and as claimed in the claims section below find support in the following examples.

### EXAMPLES

Reference is now made to the following examples, which together with the above descriptions illustrate some embodiments of the invention in a non limiting fashion.

An exemplary use-case is now described. Outline of the process from a user point of view:
1. An expert witness (or someone else) marks a set, possibly a large one, of videos for review.
2. The set is automatically processed according to at least one embodiment to:
   a. Find a likely much smaller set of “suspicious” videos likely to be deepfake.
   b. Find the time in which those videos are suspicious.
3. For all videos that are “suspicious”:
   a. Create an explainer for the expert.
   b. Present the expert witness with the suspicious video and an explanation of why it is suspicious.

At least one embodiment empowers legal practitioners and forensic experts to work together, for example, across a platform by legal practitioners as well as in another independent platform used by forensic experts who are using a tool for forensic experts to investigate media item files. Legal practitioners may run a deepfake explainability tool, based on one or more embodiments described herein, on stored files. Video and audio files may be scanned to determine if the files in question are either ‘suspicious’ for being deepfake or have ‘no evidence of AI manipulation’. For files likely being deepfake, a presentation of explainability is automatically generated, as described herein. Once the user sees the resulting presentation, the use may choose to expose the flagged files for an in-depth expert analysis by their forensic experts. Forensic experts may work on the file using a dedicated platform for forensic experts. Once the investigative work is complete, they may send their analysis and reports on the veracity of the digital legal evidence through the platform back to the legal practitioners. The aforementioned is an example of a collaborative framework that can help different stakeholders in an Electronic Discovery Reference Model (EDRM) to recognize the right and complementary roles they need to play, to highlight their respective advantage, and/or to address the need to join hands and work together in a way that creates synergy.

Referring now back to FIG. 8, the flow of the use-case for explainability of media items found to be deepfake is based on one or more embodiments described herein, applied to the use-case of legal proceedings.

At 802, the explainability for deepfake models (also referred to as authentication AI check) is run.

At 804, deepfake models are applied to media items. Explainability is provided for media items identified as likely deepfake, using one or more embodiments described herein.

At 806, the media items identified as likely deepfake and for which explainability was automatically generated may be reviewed, such as by a human to determine whether the deepfake identification in view of the explainability is correct, or an error. Correct media items may be flagged.

At 808, flagged files may be selected for analysis by forensic experts.

At 810, forensic experts may review the files.

At 812, the forensic experts may generate a report for media authenticity.

At 814, the report may be sent back to a law firm, which triggered the initial process at 802.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant deepfake detector models will be developed and the scope of the term deepfake detector model is intended to include all such new technologies a priori.

As used herein the term “about”refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional”features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of explainability of a media element identified as deepfake, comprising:
feeding the media element into a deepfake model trained to classify the media element as deepfake or not deepfake,
wherein the deepfake model is implemented as a non-explainable model;
in response to the deepfake model classifying the media element as deepfake:
automatically dividing the media element into a plurality of sub-regions;
for each respective sub-region of the plurality of sub-regions, creating a synthetic media element including the respective sub-region and excluding other sub-regions;
feeding each of a plurality of synthetic media elements into the deepfake model;
in response to the deepfake model classifying at least one of the synthetic media elements as being deepfake, creating a presentation indicating the sub-region corresponding to each at least one synthetic media elements classified as deepfake.

2. The computer implemented method of claim 1, wherein the synthetic media element includes the respective sub-region of the media element, and values denoting lack of information for the excluded sub-regions.

3. The computer implemented method of claim 1, further comprising in response to the deepfake model classifying any of the synthetic media as deepfake, further dividing each sub-region into a plurality of sub-sub-regions, wherein the synthetic media element includes the respective sub-sub-region and excludes other sub-sub-regions.

4. The computer implemented method of claim 3, wherein the automatically dividing, the creating, and the feeding, are iterated in a plurality of iterations by further dividing each sub-region into a plurality of smaller sub-sub-regions, wherein the plurality of iterations are terminated when the deepfake model does not classify any synthetic media elements of a certain sub-region as deepfake.

5. The computer implemented method of claim 3, wherein a different ensemble of deepfake models is applied at different iterations, wherein more computationally expensive deepfake models are applied at relatively later iterations.

6. The computer implemented method of claim 1, wherein the deepfake model generates a classification in response to an input and excludes an indication of specific features of the input that most significantly contributed to the classification.

7. The computer implemented method of claim 1, wherein the synthetic media element is generated in a format designed to comply with requirements for input into the deepfake model.

8. The computer implemented method of claim 1, wherein the synthetic media element is created by creating a mask corresponding to the respective sub-region, and applying the mask to the media element.

9. The computer implemented method of claim 1, wherein the synthetic media element is created for avoiding or reducing likelihood of the deepfake model classifying the synthetic media element as deepfake based on the excluded sub-regions.

10. The computer implemented method of claim 1, wherein the excluded sub-regions are generated for being non-significant for classification by the deepfake.

11. The computer implemented method of claim 1, wherein the media element comprises a video, wherein the video or image is divided into a plurality of sub-regions by segmenting a plurality of objects, each synthetic media element includes a respective object and excludes other objects and background during a time-interval of the video classified as deepfake.

12. The computer implemented method of claim 1, wherein the media element comprises a video or image, wherein the video or image is divided into a plurality of sub-regions each including an area of a frame of the video or of the image.

13. The computer implemented method of claim 1, wherein the media element comprises an audio file, wherein the audio file is divided into a plurality of sub-regions according to frequency ranges and/or sound sources, each synthetic media element includes a respective frequency range and excludes other frequency ranges, and/or includes sound from a respective sound source and excludes sound from other sound sources, during a time-interval of the audio classified as deepfake.

14. The computer implemented method of claim 1, further comprising providing a plurality of different media elements, wherein the features of claim 1 are iterated for each media element of the plurality of different media elements, for selecting a sub-set of media elements classified as deepfake, and creating a respective presentation for each media element of the sub-set.

15. The computer implemented method of claim 1, wherein the presentation includes a marking on the media element, each sub-region classified as deepfake.

16. The computer implemented method of claim 1, wherein the deepfake model comprises an ensemble of deepfake models each trained to analyze different features and/or different objects of a target media element for classifying the target media element as deepfake, wherein the presentation further includes at least one indication of a specific feature and/or a specific object of a certain deepfake model of the ensemble that classified the media element as deepfake.

17. The computer implemented method of claim 1, further comprising processing the media element and/or processing each sub-region by at least one of: applying a filter and/or changing from color to greyscale, wherein the plurality of synthetic media elements are created based on the processed sub-regions.

18. The computer implemented method of claim 1, wherein the media element is at a first resolution, dividing the media element into the plurality of sub-regions comprises converting the media element to a second resolution lower than the first resolution, and in response to classifying the at least one of the synthetic media elements as deepfake at the second resolution, for the sub-region of the at least one synthetic media elements switching to a third resolution higher than the second resolution and iterating the features of the method of claim 1 for the sub-region at the third resolution.

19. A computer implemented method of explainability of a media element identified as deepfake, comprising:
feeding the media element into each of a plurality of deepfake models of an ensemble, each deepfake model trained to analyze a specific feature for classifying the media element as deepfake or not deepfake;
identifying a sub-set of the plurality of deepfake models of the ensemble that classified the media element as deepfake; and
generating a presentation comprising specific features indicated with respect to the media element, wherein the specific features that are indicated correspond to the sub-set of the plurality of deepfake models that classified the media element as deepfake.

20. The computer implemented method of claim 19, further comprising:
for each specific feature corresponding to a specific deepfake model:
analyzing the media element to detect a plurality of instances of the specific feature,
automatically dividing the media element into a plurality of sub-regions each include a respective instance of the specific feature;
for each respective sub-region of the plurality of sub-regions, creating a synthetic media element including the respective sub-region and excluding other sub-regions;
feeding each of a plurality of synthetic media elements into the corresponding specific deepfake model,
wherein the presenting indicates the instance of the specific feature corresponding to the sub-region of the synthetic media element identified by the deepfake model as likely deepfake.

21. The computer implemented method of claim 19, where the presentation includes markings and/or explanations for plurality of different specific features corresponding to a sub-set of the plurality of deepfake models of the ensemble classifying the media element as deepfake.

22. The computer implemented method of claim 19, wherein the media element comprises a video, the specific feature includes a specific object depicted in the video, and the presentation includes the specific object marked on the video.

23. The computer implemented method of claim 19, wherein the media element comprises audio, the specific feature includes a specific audio feature, and the presentation includes an explanation of the specific audio feature or playing the specific audio feature over speakers.

24. The computer implemented method of claim 19, wherein the presentation includes a text explanation of the specific features that the sub-set of the plurality of deepfake models that detected deepfake analyze.

25. A system for explainability of a media element identified as deepfake, comprising:
at least one processor executing a code for:
feeding the media element into a deepfake model trained to classify the media element as deepfake or not deepfake,
wherein the deepfake model is implemented as a non-explainable model;
in response to the deepfake model classifying the media element as deepfake:
automatically dividing the media element into a plurality of sub-regions;
for each respective sub-region of the plurality of sub-regions, creating a synthetic media element including the respective sub-region and excluding other sub-regions;
feeding each of a plurality of synthetic media elements into the deepfake model;
in response to the deepfake model classifying at least one of the synthetic media elements as being deepfake, creating a presentation indicating the sub-region corresponding to each at least one synthetic media elements classified as deepfake.
